(19) United States
(12) Patent Application Publication
(10) Pub. No.: US 2023/0348653 A1
(43) Pub. Date: Nov. 2, 2023

(54) RADIATION-CURABLE AQUEOUS POLYURETHANE DISPERSIONS

(71) Applicant: COVESTRO (NETHERLANDS) B.V., Geleen (NL)

(72) Inventors: Ilse VAN DER HOEVEN-VAN CASTEREN, Geleen (NL); Josephus Christiaan VAN OORSCHOT, Geleen (NL); Ronald TENNEBROEK, Geleen (NL); Paulus Johannes Maria HÖNEN, Geleen (NL)

(21) Appl. No.: 17/791,356

(22) PCT Filed: Jan. 7, 2021
(86) PCT No.: PCT/EP2021/050189

§ 371 Date: Jul. 7, 2022

(30) Foreign Application Priority Data
Jan. 9, 2020 (EP) 20150988.2

(51) Int. Cl. C08G 18/32; C08G 18/34; C08G 18/67; C09D 11/101; C08G 18/08

(52) U.S. Cl. CPC C08G 18/3203; C08G 18/348; C08G 18/672; C09D 11/101; C08G 18/0866; C08G 18/0823

(57) ABSTRACT

The present invention is directed to a radiation-curable aqueous dispersion comprising a (meth)acryloyl functional polyurethane A comprising anionic dispersing groups and non-ionic dispersing groups, characterized in that (i) said polyurethane A comprises (meth)acryloyl ester functional groups in an amount of at least 0.5 mmol per g of the polyurethane A, (ii) said anionic dispersing groups comprising carboxylate and sulfonate dispersing groups, (iii) said carboxylate and sulfonate dispersing groups are present in said polyurethane A in an amount such as to result in an acid number of from 2 to 30 mg KOH/g of the polyurethane A, (iv) said carboxylate and sulfonate dispersing groups are individually present in said polyurethane A in an amount such as to result in an acid number of from 1 to 15 mg KOH/g of said polyurethane A, (v) said non-ionic dispersing groups are polyethylene oxide dispersing groups composed of at least 5 ethylene oxide repeating units, and (viii) said polyethylene oxide dispersing groups are present in said polyurethane A such that the ethylene oxide content in the polyurethane A is from 2 to 20 wt. %.

The present invention relates to the field of radiation-curable aqueous polyurethane dispersions which in particular can be used as binder in ink compositions and more in particular in ink-jet ink compositions.

Water-based inks containing water-dispersible polyurethane and pigment find an increasingly important position in the market place because they offer good performance while contributing at the same time in reducing the volatile organic content. Further, the graphic arts industry is more and more converting towards digital printing. Most common method is the use of ink-jet technology. However, such ink-jet inks must have a stable viscosity during storage and application. When an ink is jetted through a nozzle, the droplet size and drop velocity are impacted by its viscosity. This means that the position and the size of the pixel is dependent on the viscosity of the ink. In addition, the ink and thus also the radiation-curable aqueous polyurethane dispersion must have a stable pH over time (thus during storage), in particular a pH which remains over time above 6.5, more preferably above 7. If the pH of the ink decreases over time to a level below 6.5, pigment flocculation may occur resulting in that phase-separation during storage of the ink and/or clogging of the jetting nozzle may occur which must be avoided to ensure a smooth and robust printing process. Further, changes in pH of the dispersion may also impact the viscosity stability.

Further, to circumvent problems of productivity and reliability during the application of ink, the ink must have a particular behavior often referred to as “resolubility” (sometimes called reversibility or redispersibility), meaning that a dry or drying polymer obtained from an aqueous polymer composition is redispersible or resolvable in that same composition when the latter is applied thereto.

WO-A-2019/106089 is directed to radiation-curable aqueous polyurethane dispersions for ink-jet inks. The radiation curable polyurethane has an ionic group and a polyethylene oxide in a side chain thereof and is based on a (meth)acrylate or (meth)acrylamide having a hydroxyl functional group. The (meth)acrylate or (meth)acrylamide having a hydroxyl functional group makes the polyurethane radiation-curable. The ionic group is preferably a carboxylate anion introduced into the polyurethane by preferably the use of 2,2-dimethylol propionic acid. It has been found that a disadvantage of a radiation-curable aqueous dispersion of polyurethane comprising (meth)acrylate functional groups, polyethylene oxide dispersible groups and carboxylate dispersing groups is that the viscosity of the dispersion may change over time, i.e. thus during storage. Viscosity variation lowers formulation latitude. In addition, viscosity variation can have a profound effect on the performance of the formulated dispersion in the final application. Viscosity stability of an ink-jet formulation is very important because a small change in viscosity may have an impact on drop size and drop velocity of the jetted ink drop, which may result in a change in pixel size and location of the pixel. Further, it has been found that the pH stability and/or particle size stability of the dispersion during storage may be insufficient.

The object of the present invention is to improve the colloidal stability over time of radiation-curable aqueous dispersions of polyurethane comprising (meth)acryloyl ester functional groups in an amount of at least 0.5 mmol per g of polyurethane, carboxylate dispersing groups and non-ionic dispersing groups.

The object of the present invention has surprisingly been achieved by providing a radiation-curable aqueous polyurethane dispersion, wherein the polyurethane is a (meth)acryloyl functional polyurethane A comprising anionic dispersing groups and non-ionic dispersing groups, characterized in that
(i) said polyurethane A comprises (meth)acryloyl ester functional groups in an amount of at least 0.5 mmol per g of the polyurethane A,
(ii) said anionic dispersing groups comprising carboxylate and sulfonate dispersing groups,
(iii) said carboxylate and sulfonate dispersing groups are present in said polyurethane A in an amount such as to result in an acid number of from 2 to 30 mg KOH/g of the polyurethane A,
(iv) said carboxylate and sulfonate dispersing groups are individually present in said polyurethane A in an amount such as to result in an acid number of from 1 to 15 mg KOH/g of said polyurethane A,
(v) said non-ionic dispersing groups are polyethylene oxide dispersing groups composed of at least 5 ethylene oxide repeating units, and
(vi) said polyethylene oxide dispersing groups are present in said polyurethane A such that the ethylene oxide group content in the polyurethane A is from 2 to 20 wt. %.

It has surprisingly been found that the dispersions according to the invention have excellent viscosity stability over time (4 weeks @ 60° C.) despite the presence of inherently hydrolytically sensitive (meth)acryloyl ester bonds, while retaining a pH of at least 6.5 when stored for 4 weeks at a temperature of even 60° C. It has surprisingly been found that the change in viscosity of the polyurethane dispersion diluted to 20 wt. % solid content over 3 weeks, even over 4 weeks of the dispersion of the present invention when stored at 60° C. can be limited to a deviation of only 3 mPa·s or less and even to a deviation of only 2.5 mPa·s or less, whereby the starting point to calculate the change in viscosity is 1 day after preparation, and the deviation between the viscosity measured after 7 days and the viscosity measured after 28 days when stored at 60° C. is limited to at most 1 mPa·s, preferably to at most 0.5 mPa·s, while the pH of the dispersions of the invention diluted to 20 wt. % solid content remains above 6.5 for at least 3 weeks, even for at least 4 weeks when stored at 60° C.

An additional advantage of the present invention is that the dispersions of the invention have a good particle size stability over time. Particle size increase over time may result in potential agglomeration of the particles resulting in potential sedimentation and thus a poor resistance to phase separation and thus poor long-term storage stability.

The dispersion of the invention preferably has a viscosity stability defined as follows: the change in viscosity over time of the dispersion diluted to 20 wt. % solid content and stored for 4 weeks at 60° C., preferably for 5 weeks, more preferably for 6 weeks is at most 3 mPa·s, preferably at most 2.5 mPa·s, whereby the starting point to calculate the change in viscosity is 1 day after preparation (i.e. the starting point to calculate the change in viscosity is the dispersion that has been stored for 1 day at room temperature) and the deviation between the viscosity measured after 7 days and the viscosity measured after 28 days of the dispersion diluted to 20 wt. % solid content and stored at 60° C. is at most 1 mPa·s, preferably at most 0.5 mPa·s. The dispersion of the invention preferably has a pH stability defined as follows: the pH of the dispersion diluted to 20 wt. % solid content and stored at 60° C. remains at least 6.5 after 4 weeks, preferably 5 weeks and most preferably 6 weeks. The dispersion of the invention preferably has a particle size stability defined as follows: the change in particle size of the dispersion diluted to 20 wt. % solid content and stored at room temperature and/or 60° C. for 4 weeks is at most 20 nm, more preferably at most 15 nm and/or the particle will change less than 30%, preferably less than 25%, most preferably less than 20% when stored for 4 weeks, preferably 6 weeks, more preferably 8 weeks at room temperature, more preferably at 45° C., most preferably at 60° C. whereby the starting point to calculate the change in particle size is the dispersion that has been stored for 1 day at room temperature. Furthermore, the dispersion diluted to 20 wt. % solid content preferably does not show settling, formation of sediment and phase separation upon storage at room temperature or at 60° C. for 4 weeks, preferably for 5 weeks, more preferably for 6 weeks.

The dispersion of the invention preferably has a colloidal stability defined as follows: (i) the change in viscosity over time of the dispersion diluted to 20 wt. % solid content and stored at 60° C. for 4 weeks is at most 3 mPa·s, preferably at most 2.5 mPa·s, whereby the starting point to calculate the change in viscosity is the dispersion that has been stored for 1 day at room temperature, and the deviation between the viscosity measured after 7 days and the viscosity measured after 28 days of the dispersion diluted to 20 wt. % solid content and stored at 60° C. is at most 1 mPa·s, preferably at most 0.5 mPa·s; (ii) the pH of the dispersion diluted to 20 wt. % solid content and stored at 60° C. remains at a value of at least 6.5 after 4 weeks; (iii) the change in particle size of the dispersion diluted to 20 wt. % solid content and stored at 60° C. for 4 weeks is at most 20 nm, preferably at most 15 nm and/or the particle will change less than 30%, preferably less than 25%, most preferably less than 20% when stored for 4 weeks, preferably 6 weeks, more preferably 7 weeks at room temperature, more preferably at 45° C., most preferably at 60° C., whereby the starting point to calculate the change in particle size is the dispersion that has been stored for 1 day at room temperature; and (iv) the dispersion diluted to 20 wt. % solid content does not show settling, formation of sediment and phase separation upon storage at 60° C. for 4 weeks, preferably for 5 weeks, more preferably for 6 weeks.

The aqueous dispersion according to the present invention is radiation-curable. By radiation-curable is meant that radiation is required to initiate crosslinking. Optionally a photoinitiator (PI) may be added to the radiation-curable aqueous dispersion of the invention to assist radiation curing, especially if curing is by UV radiation. However, if curing is to be achieved by, for example, electron beam (EB) then a PI may not be needed. Preferably, the radiation-curable aqueous dispersion of the invention comprises a photo-initiator and UV-radiation is applied to obtain a cured coating. Thus the aqueous dispersion is preferably UV radiation-curable.

The dispersion according to the invention contains ethylenically unsaturated (C═C) bond functionality which under the influence of irradiation (optionally in combination with the presence of a (photo)initiator) can undergo crosslinking by free radical polymerisation. It is especially preferred that this irradiation is UV irradiation.

The ethylenically unsaturated bond functionality concentration (also referred to as the C═C bond concentration) of the dispersion of the present invention is preferably in the range from 0.5 to 8.0 mmol per g of the summed weight amount of polyurethane A and optional radiation-curable diluent present in the dispersion of the invention, preferably in the range from 0.5 to 7.0, more preferably from 0.5 to 6.0, more preferably from 0.6 to 5.5, even more preferably from 2 to 5 mmol C═C per g of polyurethane and optional radiation-curable diluent. The radiation-curable C═C bonds are preferably chosen from (meth)acryloyl groups, most preferably acryloyl groups. In the present invention, at least a part of the (meth)acryloyl groups are introduced in the dispersion by incorporating (meth)acryloyl ester functional groups in the polyurethane. As used herein, the amount of C═C bonds present in the dispersion is determined by adding up all radiation- curable C═C functionality from the components used to prepare the dispersion. Hence, the amount of C═C bonds present in the dispersion represents the radiation-curable C═C bonds present in the polyurethane A and radiation-curable diluent. As used herein, the expression per g of the polyurethane A is determined by the total weight amount of components used to prepare the polyurethane A from which the building blocks of the polyurethane are emanated.

The radiation-curable aqueous dispersion of the invention comprises radiation-curable polyurethane A in disperse form (i.e. the dispersion comprises dispersed particles of radiation-curable polyurethane A), wherein said polyurethane A comprises (meth)acryloyl ester functional groups in an amount of at least 0.5 mmol per g of the polyurethane A. The amount of (meth)acryloyl ester functional groups present in the polyurethane A is at least 0.5 mmol per g of the polyurethane A, i.e. the summed amount of methacryloyl ester functional groups and acryloyl ester functional groups present in the polyurethane A is at least 0.5 mmol per g of the polyurethane A. The amount of (meth)acryloyl ester functional groups present in the polyurethane A is preferably at least 1.0 mmol per g of the polyurethane A, more preferably at least 1.5 mmol per g of the polyurethane A, even more preferably at least 2.0 mmol per g of the polyurethane A. The amount of (meth)acryloyl ester functional groups present in the polyurethane A is preferably at most 10 mmol per g of the polyurethane A, more preferably at most 8 mmol per g of the polyurethane A and most preferably at most 7 mmol per g of the polyurethane A.

Preferably, at least 50 mol % of the ethylenically unsaturated bond concentration of the polyurethane A, more preferably at least 70 mol %, even more preferably at least 75 mol %, even more preferably at least 90 mol % and most preferably 100 mol % of the ethylenically unsaturated bond concentration of the polyurethane A is present in the polyurethane A as (meth)acryloyl ester functional groups. Said (meth)acryloyl ester functional groups are preferably introduced in said polyurethane by chemically incorporating at least one polyester acrylate, at least one epoxy acrylate, at least one polyether acrylate (such as polypropyleneglycol acrylate and polyethylene glycol acrylate), hydroxyethyl(meth)acrylate, hydroxypropyl(meth)acrylate, hydroxybutyl(meth)acrylate, trimethylolpropane di(meth)acrylate and their (poly)ethoxylated and/or (poly)propoxylated equivalents, pentaerythritol tri(meth)acrylate and their (poly)ethoxylated and/or (poly)propoxylated equivalents, ditrimethylolpropane tri(meth)acrylate and their (poly)ethoxylated and/or (poly)propoxylated equivalents, dipentaerythritol penta(meth)acrylate and their (poly)ethoxylated and/or (poly)propoxylated equivalents, glycerol diacrylate and their (poly)ethoxylated and/or (poly)propoxylated equivalents, and any mixture thereof into said polyurethane. More preferably, said (meth)acryloyl ester functional groups are introduced in said polyurethane by chemically incorporating hydroxyethyl(meth)acrylate, hydroxypropyl(meth)acrylate, hydroxybutyl(meth)acrylate and any mixture thereof and/or trimethylolpropane di(meth)acrylate, pentaerythritol tri(meth)acrylate and their (poly)ethoxylated and/or (poly)propoxylated equivalents, dipentaerythritol penta(meth)acrylate and their (poly)ethoxylated and/or (poly)propoxylated equivalents, ditrimethylolpropane tri(meth)acrylate and their (poly)ethoxylated and (poly)propoxylated equivalents and any mixture thereof into said polyurethane. In case polyethoxylated equivalents are used, the polyethoxylated equivalent preferably has less than 5 ethylene oxide repeating units. In case polyethoxylated equivalents having at least 5 ethylene oxide repeating units are used, the polyethylene oxide groups present in such polyethoxylated equivalents are also included in the calculation for the ethylene oxide content in polyurethane A.

An acryloyl ester functional group has the following formula:

H₂C═C(C═O)O—

A methacryloyl ester functional group has the following formula:

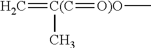

The polyurethane A preferably comprises acryloyl ester functional groups.

A dispersion refers to a two-phase system where one phase contains discrete particles (colloidally dispersed particles) distributed throughout a bulk substance, the particles being the disperse phase and the bulk substance the continuous phase or the dispersing medium. In the present invention, the continuous phase of the dispersion predominantly comprises water, but some amount of organic compounds such as for example soluble polymer and organic liquids is allowed. This in contrast to organic solvent based dispersions in which organic solvent is the major part of the carrier fluid. Preferably the continuous phase of the dispersion of the invention comprises at least 75 wt. %, more preferably at least 85 wt. % of water (relative to the continuous phase).

In accordance with the present invention, the term “polyurethane dispersion” refers to dispersion of polymers containing urethane groups and optionally urea groups, further referred to as polyurethane(s). The dispersion of the invention comprises polyurethane in dispersed form at a starting pH of the aqueous dispersing medium of preferably from 7 to 9, i.e. the dispersion comprises polyurethane particles with usually an average particle size ranging from 15 nm to 200 nm, preferably an average particle size ranging from 20 nm to 150 nm. These polymers also contain hydrophilic functionality to obtain a stable dispersion of the polyurethane in the aqueous dispersing medium.

In accordance with the present invention, the polyurethane A is stabilized in the dispersion at least through anionic functionality incorporated into the polyurethane A such as neutralized acid groups (“anionically stabilized polyurethane A dispersion”) and through non-ionic functionality. Thus, the polyurethane A is for a part anionically hydrophilized by chemically incorporating anionic functional groups into the polyurethane A to provide a part of the hydrophilicity required to enable the polyurethane A to be stably dispersed in the aqueous dispersing medium. The anionic functionality in combination with the non-ionic functionality are capable to render the polyurethane A polymer dispersible in the aqueous dispersing medium, either directly or after reaction with a neutralizing agent, and to render the dispersed polyurethane A particles stable in the aqueous dispersing medium. The polyurethane A comprises carboxylate and sulfonate dispersing groups as anionic dispersing groups. The anionic dispersing groups present in polyurethane A preferably consist of carboxylate and sulfonate dispersing groups. The carboxylate dispersing groups and sulfonate dispersing groups are present in said polyurethane A in such an amount such as to result in an acid number originating from the total amount of carboxylate and sulfonate dispersing groups present in polyurethane A of from 2 to 30 mg KOH/g of the polyurethane A. The carboxylate dispersing groups are present in said polyurethane A in an amount such as to result in an acid number originating from the carboxylate dispersing groups present in polyurethane A of from 1 to 15 mg KOH/g of the polyurethane A. The sulfonate dispersing groups are present in said polyurethane A in an amount such as to result in an acid number originating from the sulfonate dispersing groups present in polyurethane A of from 1 to 15 mg KOH/g of the polyurethane A. For example, sulfonate groups may be incorporated into the polyurethane A by using a sulfonate containing compound, such as for example Vestamin® A95, as reactant. The acid number (also referred herein as acid value) is the mass of potassium hydroxide (KOH) in milligrams that is required to neutralize one gram of chemical substance. As used herein, the acid number is calculated. Preferably, the polyurethane A comprises carboxylic acid groups and/or sulfonic acid groups, which become anionic when deprotonated. Carboxylic acid groups and sulfonic acid groups, which become anionic when deprotonated, are also referred to as potentially anionic groups. The deprotonation is usually obtained by neutralizing the corresponding acid groups suitably prior to, during or after formation of the polyurethane A prepolymer, more suitably after formation of the polyurethane A prepolymer. Preferably the carboxylate groups present in the polyurethane A are incorporated into the polyurethane A by chemically incorporation of carboxylic acid groups which become anionic by neutralizing. Preferably, the carboxylic acid groups are incorporated into the polyurethane A by chemically incorporation of a hydroxy-carboxylic acid(s) into the polyurethane A to provide after deprotonation a part of the hydrophilicity required to enable the polyurethane A to be stably dispersed in the aqueous dispersing medium. Furthermore, carbon/late groups improve pH buffer capacity. The hydroxy-carboxylic acid(s) is preferably a dihydroxy alkanoic acid(s), preferably α,α-dimethylolpropionic acid and/or α,α-dimethylolbutanoic acid. More preferably, the dihydroxy alkanoic acid(s) is α,α-dimethylolpropionic acid (DMPA). Preferably, the sulfonate groups are incorporated into the polyurethane A by using a sulfonate containing compound as reactant after the prepolymer preparation. Preferably, the sulfonate containing compound is a diaminosulphonate corresponding to the following general formula:

H₂N—A—NH—B—SO₃₋Cat⁺ wherein A and B represent aliphatic hydrocarbon radicals having from 2 to 6 carbon atoms, preferably ethylene radicals, and Cat⁺ represents an optionally substituted ammonium cation or preferably a sodium or potassium cation, more preferably sodium cation. A very suitable sulfonate containing compound is Vestamin® A95 obtainable from Evonik.

The neutralizing agent used to deprotonate (neutralize) the carboxylic acid groups and/or sulfonic acid groups is preferably selected from the group consisting of ammonia, a (tertiary) amine, a metal hydroxide and any mixture thereof. Suitable tertiary amines include triethylamine and N,N-dimethylethanolamine. Suitable metal hydroxides include alkali metal hydroxides, for example lithium hydroxide, sodium hydroxide and potassium hydroxide. Preferably, at least 30 mol %, more preferably at least 50 mol % and most preferably at least 70 mol % of the total molar amount of the neutralizing agent is alkali metal hydroxide, preferably selected from the group consisting of lithium hydroxide, sodium hydroxide, potassium hydroxide and any mixture thereof. Preferably the neutralizing agent used to deprotonate (neutralize) the carboxylic acid groups and/or the sulfonic acid groups is an alkali metal hydroxide.

Optionally external surfactants are added. Preferably, the stabilization of the polyurethane A in the dispersion is not achieved by adding external (anionic) surfactants.

The polyurethane A is further stabilized in the dispersion through non-ionic functionality incorporated into the polyurethane A. Thus, the polyurethane A is at least for a part non-ionically stabilized by chemically incorporating non-ionic groups into the polyurethane A to provide at least a part of the hydrophilicity required to enable the polyurethane A to be stably dispersed in the aqueous dispersing medium. The non-ionic water-dispersing groups are polyethylene oxide groups.

Accordingly, the groups which are capable to render the polyurethane A dispersible in the aqueous dispersing medium and to render the dispersed polyurethane A particles stable in the aqueous dispersing medium are non-ionic groups in combination with anionic groups. The polyurethane A is thus stabilized in the dispersion through non-ionic and anionic functionality incorporated into the polyurethane A. Radiation-curable aqueous dispersions of the present invention in which the polyurethane A is stabilized in the dispersion through non-ionic and anionic functionality incorporated into the polyurethane A are in particular suitable for making inks. To circumvent problems of productivity and reliability during the application of ink, the ink must have a particular behavior often referred to as “resolubility” (sometimes called reversibility or redispersibility), meaning that a dry or drying polymer obtained from an aqueous polymer composition is redispersible or resolvable prior to radiation cure in that same composition when the latter is applied thereto. It has been found that an improved resolubility of the polymer can be obtained by also non-ionic stabilization of the polyurethane A however this contributes to the disadvantage of increased water-sensitivity of the cured ink. In view of this, the amount of non-ionic groups is preferably at most 20 wt. %, more preferably at most 15 wt. % (on solids of the polyurethane A). The amount of polyethylene oxide dispersing groups present in said polyurethane A is such that the ethylene oxide content in the polyurethane A is in the range of from 2 to 20 wt. %, preferably at least 5 wt. %, more preferably at least 7 wt. % and preferably at most 18 wt. %, more preferably at most 16 wt. %, whereby the ethylene oxide content is given relative to the total weight amount of components used to prepare the polyurethane A from which the building blocks of the polyurethane A are emanated. Preferably, the ethylene oxide groups are incorporated into the polyurethane A by chemically incorporation of a polyethylene oxide into the polyurethane A.

The carboxylate dispersing groups and sulfonate dispersing groups are present in said polyurethane A in an amount such that the summed amount of carboxylate and sulfonate dispersing groups results in an acid number of from 2 to 30 mg KOH/g of the polyurethane A, preferably from 2 to 20 mg KOH/g of the polyurethane A. Preferably, the carboxylate dispersing groups and sulfonate dispersing groups are present in said polyurethane A in an amount such as to result in an acid number of at least 3 mg KOH/g of said polyurethane A, more preferably at least 4 mg KOH/g of said polyurethane A and preferably at most 20 mg KOH/g of said polyurethane A, more preferably at most 16 mg KOH/g of said polyurethane A, more preferably at most 12 mg KOH/g of said polyurethane A.

The carboxylate dispersing groups are present in said polyurethane A in an amount such as to result in an acid number of from 1 to 15 mg KOH/g of the polyurethane A. Preferably, the carboxylate dispersing groups are present in said polyurethane A in an amount such as to result in an acid number of at least 2 mg KOH/g of said polyurethane A, more preferably at least 3 mg KOH/g of said polyurethane A. Preferably, the carboxylate dispersing groups are present in said polyurethane A in an amount such as to result in an acid number of at most 12 mg KOH/g of said polyurethane A, more preferably at most 10 mg KOH/g of said polyurethane A.

The sulfonate dispersing groups are present in said polyurethane A in an amount such as to result in an acid number of from 1 to 15 mg KOH/g of the polyurethane A. Preferably, the sulfonate dispersing groups are present in said polyurethane A in an amount such as to result in an acid number of at least 2 mg KOH/g of said polyurethane A, more preferably at least 3 mg KOH/g of said polyurethane A. Preferably, the sulfonate dispersing groups are present in said polyurethane A in an amount such as to result in an acid number of at most 12 mg KOH/g of said polyurethane A, more preferably at most 10 mg KOH/g of said polyurethane A.

For further improving the resolubility of the polyurethane A, the number average molecular weight Mₙ of the polyurethane A is preferably in the range from 800 to 50000 Daltons, more preferably in the range of 1000 to 25000 Daltons, most preferably in the range of 1100 to 20000 Daltons, especially preferred in the range of 1200 to 15000 Daltons; and the weight average molecular weight M_{w} of the polyurethane A is preferably lower than 100000 Daltons, more preferably lower than 80000 Daltons.

The dispersed particles present in the dispersion according to the invention preferably have an average particle size of at least 15 nm and preferably at most 200 nm, whereby the average particle size is measured as described in the experimental part herein below.

The polyurethane A present in the dispersion of the present invention preferably comprises as building blocks at least
(a) at least one polyisocyanate,
(b) at least one component containing at least one isocyanate-reactive group and containing or providing at least one (meth)acryloyl ester functional group,
(c) at least one component containing at least one isocyanate-reactive group and at least one carboxylate dispersing group which is capable to render said polyurethane dispersible in the aqueous dispersing medium either directly or after reaction with a neutralizing agent to provide a salt, whereby component (c) being different from component (b),
(d) at least one component containing at least one isocyanate-reactive group and at least one sulfonate dispersing group which is capable to render said polyurethane dispersible in the aqueous dispersing medium either directly or after reaction with a neutralizing agent to provide a salt, whereby component (d) being different from component (b) and (c),
(e) at least one component containing at least one isocyanate-reactive group and polyethylene oxide dispersing groups which are capable to render said polyurethane dispersible in the aqueous dispersing medium, whereby component (e) being different from component (b), (c) and (d),
(f) optionally at least one active-hydrogen chain-extending compound being different from component (b), (c), (d) and (e), and
(g) optionally at least one component containing at least two isocyanate-reactive groups, whereby component (g) being different from component (b), (c), (d), (e) and (f).

The summed amount of components (c), (d) and (e) is such that the amount of carbon/late, sulfonate and ethylene oxide dispersing groups is sufficiently high to obtain a colloidal stable dispersion, preferably a dispersion with a colloidal stability as defined herein above.

Isocyanate-reactive groups include —OH, —SH, —HN—, and —NH₂. Preferred reactive groups are —OH, —HN—, and —NH₂.

Methods for preparing polyurethanes are known in the art and are described in for example the Polyurethane Handbook 2^{nd} Edition, a Carl Hanser publication, 1994, by G. Oertel. The polyurethane A present in the radiation-curable aqueous dispersion may be prepared in a conventional manner by reacting at least (a), (b), (c), (d), (e) and optionally (f) and (g) by methods well known in the prior art. Preferably an isocyanate-terminated polyurethane pre-polymer (I) is first formed by the reaction of at least components (a), (b), (c), (e) and optionally (g) which is then further reacted with component (d) and optionally (f).

### Component (a)

Component (a) is preferably at least one organic difunctional isocyanate. The amount of component (a) relative to the total amount of components used to prepare the polyurethane A is usually from 5 to 55 wt. % and preferably from 10 to 45 wt. %, most preferably 15 to 40 wt. %.

Examples of suitable organic difunctional isocyanates (component (a)) include ethylene diisocyanate, 1,5-pentane diisocyanate, 1,6-hexamethylene diisocyanate (HDI), 2,2,4-trimethyl-1,6-hexamethylene diisocyanate, isophorone diisocyanate (IPDI), cyclohexane-1,4-diisocyanate, dicyclohexylmethane diisocyanate such as 4,4′-dicyclohexylmethane diisocyanate (4,4′-H₁₂ MDI), p-xylylene diisocyanate, p-tetramethylxylene diisocyanate (p-TMXDI) (and its meta isomer m-TMXDI), 1,4-phenylene diisocyanate, hydrogenated 2,4-toluene diisocyanate, hydrogenated 2,6-toluene diisocyanate,

4,4′-diphenylmethane diisocyanate (4,4′-MDI), polymethylene polyphenyl polyisocyanates, 2,4′-diphenylmethane diisocyanate, 3(4)-isocyanatomethyl-1-methyl cyclohexyl isocyanate (IMCI) and 1,5-naphthylene diisocyanate. Preferred organic difunctional isocyanates are IPDI, H₁₂MDI and HDI. Mixtures of organic difunctional isocyanates can be used. Most preferred organic difunctional isocyanates is H₁₂MDI.

### Component (b)

Component (b) is a component(s) containing or providing a (meth)acryloyl ester functional group(s). Preferably, component (b) is a component(s) containing a (meth)acryloyl ester functional group(s) and an isocyanate-reactive group(s). The isocyanate-reactive groups of component (b) are preferably hydroxyl groups.

Preferably, component (b) is selected from the group consisting of polyester acrylates, epoxy acrylates, polyether acrylates (such as polypropyleneglycol acrylate and polyethylene glycol acrylate), hydroxyethyl(meth)acrylate, hydroxypropyl(meth)acrylate, hydroxybutyl(meth)acrylate, trimethylolpropane di(meth)acrylates and their (poly)ethoxylated and/or (poly)propoxylated equivalents, pentaerythritol tri(meth)acrylate and their (poly)ethoxylated and/or (poly)propoxylated equivalents, dipentaerythritolpentaacrylate and their (poly)ethoxylated and/or (poly)propoxylated equivalents, ditrimethylolpropane tri(meth)acrylate and their (poly)ethoxylated and/or (poly)propoxylated equivalents, glycerol diacrylate and their (poly)ethoxylated and/or (poly)propoxylated equivalents, and any mixture thereof. More preferably, component (b) is selected from the group consisting of hydroxyethyl(meth)acrylate, hydroxypropyl(meth)acrylate, hydroxybutyl(meth)acrylate and any mixture thereof and/or from the group consisting of trimethylolpropane di(meth)acrylates, pentaerythritol tri(meth)acrylate, ditrimethylolpropane tri(meth)acrylate and their (poly)ethoxylated and (poly)propoxylated equivalents and any mixture thereof. In case polyethoxylated equivalents are used, the polyethoxylated equivalent preferably has less than 5 ethylene oxide repeating units. In case polyethoxylated equivalents having at least 5 ethylene oxide repeating units are used, the polyethylene oxide groups present in such polyethoxylated equivalents are also included in the calculation for the ethylene oxide content in polyurethane A.

Preferably, the amount of component (b) relative to the total amount of components used to prepare the polyurethane A is chosen such that the amount of (meth)acryloyl ester functional groups in the polyurethane A is as defined above.

### Component (c)

Component (c) is at least one component containing an isocyanate-reactive group(s) and a carboxylate group(s) which is capable to render the polyurethane A dispersible in the aqueous dispersing medium either directly or after reaction with a neutralizing agent to provide a salt, whereby component (c) being different from component (b). The isocyanate-reactive groups of component (c) are preferably hydroxyl groups. Preferably, the amount of component (c) relative to the total weight amount of components used to prepare the polyurethane A is chosen such as to result in an acid number of from 1 to 15 mg KOH/g originating from the carboxylate groups present in said polyurethane A. Preferred components (c) and preferred amounts are as described above.

### Component (d)

Component (d) is at least one component containing an isocyanate-reactive group(s) and a sulfonate group(s) which is capable to render the polyurethane A dispersible in the aqueous dispersing medium either directly or after reaction with a neutralizing agent to provide a salt, whereby component (d) being different from component (b) and (c). The isocyanate-reactive groups of component (d) are preferably —NH— and/or —NH₂ groups. Preferably, the amount of component (d) relative to the total weight amount of components used to prepare the polyurethane A is chosen such as to result in an acid number of from 1 to 15 mg KOH/g originating from the sulfonate groups present in said polyurethane A. Preferred components (d) and preferred amounts are as described above.

### Component (e)

Component (e) is at least one component containing an isocyanate-reactive group(s) and polyethylene oxide dispersing groups composed of at least 5 ethylene oxide repeating units, whereby component (e) being different from component (b), (c) and (d). The isocyanate-reactive groups of component (e) are preferably hydroxyl groups. Preferably, the amount of component (e) relative to the total weight amount of components used to prepare the polyurethane A is chosen such as to result in an amount of ethylene oxide groups in the polyurethane A of from 2 to 20 wt. %.

Preferred components (e) are polyols having no (meth)acryloyl groups and having polyethylene oxide dispersing groups composed of at least 5 ethylene oxide repeating units. Preferred components (e) are polyethylene glycols having at least 5 ethylene oxide repeating units, preferably at least 10, more preferably at least 15 ethylene oxide repeating units and preferably at most 120, more preferably at most 80 and even more preferably at most 40 ethylene oxide repeating units. More preferred components (e) are polyethylene glycols having from 10 to 60 and preferably from 15 to 30 ethylene oxide repeating units. Preferred amounts of component (e) are as described above.

### Component (g)

Component (g) is at least one component containing at least two isocyanate-reactive groups, whereby component (g) being different from component (b), (c), (d), (e) and (f). Component (g) is preferably selected from the group consisting of polyether polyols, polythioether polyols, polyester polyols, polycarbonate polyols, polyacetal polyols, polyvinyl polyols, polysiloxane polyols and any mixture thereof. The amount of polyester polyol and polycarbonate polyol used for preparing said polyurethane is preferably less than 30 wt. %, more preferably less than 20 wt. %, more preferably less than 15 wt. %, more preferably less than 10 wt. %, more preferably less than 5 wt. % and most preferably 0. Most preferably component (g) is one or more polyether polyol. In order to further improve the resolubility of the polyurethane A, the amount of component (g) used for preparing said polyurethane is preferably less than 30 wt. %, more preferably less than 25 wt. %, more preferably less than 20 wt. %, more preferably less than 15 wt. %, more preferably less than 10 wt. %.

In an embodiment of the present invention, the polyurethane A present in the dispersion of the present invention may further comprise as building blocks a component(s) containing an isocyanate-reactive group(s) and a (meth)acrylamide functional group(s). Examples of such components are N-hydroxymethyl(meth)acrylamide, N-hydroxyethyl(meth)acrylamide, N-hydroxypropyl(meth)acrylamide, N,N-bis(hydroxyethyl)acrylamide, N,N-bis(hydroxypropyl)acrylamide and any mixture thereof. In a preferred embodiment of the present invention, the polyurethane A present in the dispersion of the present invention contains less than 0.2 mmol of (meth)acrylamide functional group(s) per g of the polyurethane A, more preferably the polyurethane A present in the dispersion of the present invention is free of (meth)acrylamide functional group(s). Accordingly, in this preferred embodiment, the polyurethane A preferably does not comprise as building blocks a component(s) containing an isocyanate-reactive group(s) and an (meth)acrylamide functional group(s).

An acrylamide functional group has the following formula:

H₂C═C(C═O)NR—, whereby R is H or C.

A methacrylamide functional group has the following formula:

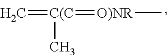

whereby R is h or C.

Preferably a polyurethane pre-polymer (I) is formed by the reaction of at least components (a), (b), (c), (e) and optionally (g) to obtain a polyurethane prepolymer with a NCO/(isocyanate-reactive groups from components (b), (c), (e) and (g)) ratio higher than 1, the polyurethane prepolymer (i.e. an isocyanate terminated polyurethane pre-polymer) is then further reacted with component (d), preferably the sodium salt of 2-aminoethyl-2-aminoethanesulfonic acid which is also an active hydrogen containing chain-extending component but considered herein a component (d), and optionally with component (f). Active hydrogen-containing chain extending components (f), which may be reacted with the isocyanate-terminated pre-polymer include water, amino-alcohols, primary or secondary diamines or polyamines (including compounds containing a primary amino group and a secondary amino group), hydrazine and substituted hydrazines. Examples of such chain extending compounds useful herein include 2-(methylamino)ethylamine, aminoethyl ethanolamine, aminoethylpiperazine, diethylene triamine, and alkylene diamines such as ethylene diamine, and cyclic amines such as isophorone diamine. Also compounds such as hydrazine, azines such as acetone azine, substituted hydrazines such as, for example, dimethyl hydrazine, 1,6-hexamethylene-bis-hydrazide, carbodihydrazide, hydrazides of dicarboxylic acids, adipic acid dihydrazide, oxalic acid dihydrazide and isophthalic acid dihydrazide. Hydrazides made by reacting lactones with hydrazine, bis-semi-carbazide, and bis-hydrazide carbonic esters of glycols may be useful. A preferred chain extending compound is water. The isocyanate and isocyanate reactive groups of the components used to prepare the polyurethane A (excluding water as chain extending compound) are preferably present in a respective mole ratio of ≤1.5:1, more preferably in the range of from 0.8:1 to 1.5:1, preferably from 1.05:1 to 1.5:1 and even more preferably from 1.1:1 to 1.5:1.

The radiation-curable aqueous dispersion according to the present invention preferably further comprises a buffer, preferably selected from the group consisting of NaHCO₃, sodium bitartrate, Na₂HPO₄, NaH₂PO₄, KHCO₃, K₂HPO₄, KH₂PO₄, potassium bitartrate or a mixture thereof, more preferably a phosphate buffer and even more preferably Na₂HPO₄. The presence of a buffer further improves the viscosity stability, pH stability and/or particle size stability of the radiation-curable aqueous dispersion.

The radiation-curable aqueous dispersion according to the present invention optionally contains radiation-curable diluent, i.e. multifunctional ethylenically unsaturated components which under the influence of irradiation (optionally in combination with the presence of a (photo)initiator) can undergo crosslinking by free radical polymerisation, but being unreactive towards isocyanate groups (i.e. containing no functionality which is capable to react with an isocyanate group) under the conditions of the polyurethane preparation reaction, and which are able to reduce the viscosity of the composition, for example by adding radiation-curable diluent during the synthesis of the polyurethane A and/or by adding radiation-curable diluent to the dispersion.

The radiation-curable aqueous dispersion according to the present invention preferably comprises polyurethane A in an amount of from 10 to 50% by solids weight, based on the total solids weight of the dispersion.

The present invention further relates to a coating composition comprising the dispersion as described above. As used herein, coating compositions also include ink, primer or overprint varnish composition. The coating composition preferably further comprises a photo-initiator. The coating composition according to the invention can be applied to any kind of substrate, such as for example wood, leather, concrete, textile, plastic, vinyl floors, glass, metal, ceramics, paper, wood plastic composite, glass fiber reinforced materials. The thickness of the dry coating on the substrate is preferably from 1 to 200 micron, more preferably from 5 to 150 micron and most preferably from 15 to 90 microns. In case the coating composition is an ink, primer or overprint varnish composition applied by printing techniques used in the graphic arts, the thickness of the dry ink is preferably from 0.005 to 35 micron, more preferably from 0.05 to 25 micron and most preferably from 4 to 15 microns.

The present invention further relates to a method for coating a substrate, where the method comprises

(i) applying an aqueous coating composition according to the invention or obtained with the process according to the invention to the substrate; and
(ii) physically drying (by evaporation of volatiles) and curing by radiation (preferably UV radiation) of the aqueous coating composition to obtain a coating.

The present invention further relates to a substrate having a coating obtained by (i) applying an aqueous coating composition according to the invention or obtained with the process according to the invention to a substrate and (ii) physically drying and curing by radiation (preferably UV-radiation) of the aqueous coating composition to obtain a coating. The substrate is preferably selected from the group consisting of textile, paper, wood, metal, plastic, linoleum, concrete, glass and any combination thereof. More preferably, the substrate is selected from the group consisting of paper, wood, PVC, linoleum, metal, textile and any combination thereof.

Ink compositions according to the invention can suitably be used in digital printing ink formulations, more preferred ink-jet printing formulations. Digital printing is a method of printing from a digital-based image directly to a variety of media. For ink applications, the dispersion is mixed with a pigment (possibly a self-dispersible pigment or a pigment in combination with a suitable dispersant) in an aqueous media (optionally including water soluble organics like glycols, glycol ethers, glycerin) to form an ink. The ink will be called a formulation and can include other additives such as humectants, other binders, viscosity modifiers, surface active agents, corrosion inhibitors, etc. The amount of polyurethane A in the ink composition is usually in the range from 1 to 25 wt. %, preferably in the range from 2 to 20 wt. %, relative to the total weight of the ink composition.

The present invention is now illustrated by reference to the following examples. Unless otherwise specified, all parts, percentages and ratios are on a weight basis.

### ComponentS AND ABBREVIATIONS USED

IPDI=Desmodur I, Isophorone diisocyanate, from Covestro
DesW=Desmodur W, 4,4- dicyclohexyl methane diisocyanate from Covestro
Ymer N120=Polymeric nonionic dispersing compound, (ethylene oxide content 84 wt. %, OH-number=113 mg KOH/g) from Perstorp polyols
MPEG750=Methoxy polyethylene glycol 750 (OH-number=75 mg KOH/g), available from BASF
DMPA=Dimethylolpropionic acid available from Perstorp polyols
pTHF650=Polytetramethylene ether glycol (OH-number=172 mg KOH/g), available from BASF
pTHF1000=Polytetramethylene ether glycol (OH-number=112 mg KOH/g), available from BASF
Agisyn 2830=DPHA, mixture of reaction products of dipentaerythritol and acrylic acid, (OH-number=50 mg KOH/g), available from DSM
Agisyn 2824=mixture of reaction products of propoxylated pentaerythritol and acrylic acid (OH-number=90 mg KOH/g), available from DSM
Agisyn 2884=mixture of reaction products of pentaerythritol and acrylic acid (OH-number=125 mg KOH/g), available from DSM
Agisyn 1010=BisphenolA epoxy acrylate, available from DSM
BHT=Butylated hydroxyl toluene available from Merisol
KOH 15%=Potassium hydroxide, 15% solution in water from Brenntag

Vestamin® A95=Solution of sodium salt of 2-aminoethyl-2-aminoethanesulfonic acid in water [51 wt %] from Evonik
Acetone=solvent available from Brenntag
BYK011=defoamer from Byk
Bismuthneodecanoate=Catalyst from TIB chemicals AG
Disodiumphosphate available from Brenntag

### Solid Content

The solid content of the dispersion was measured on a HB43-S halogen moisture analyzer from Mettler Toledo at a temperature of 105° C.

### Viscosity

The viscosity of the binder after preparation was determined using a Brookfield LV (sp61, 60 rpm, RT)

The viscosity stability of all binders diluted to 20% solids was determined in time using a

Brookfield LV with ULA adapter (60 rpm, 25° C.).

### Average Particle Size PS

The intensity average particle size, z-average, has been determined by photon correlation spectroscopy using a Malvern Zetasizer Nano ZS. Samples are diluted in demineralized water to a concentration of from 1 to 2.5 g dispersion/liter. Measurement temperature 25° C. Angle of laser light incidence 173° . Laser wavelength 633 nm.

### Size Exclusion Chromatography in HFIP

The molecular weight distribution is measured with two silica modified 7 μm PFG columns at 40° C. on a Waters Alliance e2695 LC system with a Waters 2414 DRI detector and a Waters 2996 PDA detector. Hexafluoro isopropanol (HFIP) and PTFA 0.1% is used as eluent with a flow of 0.8 mL/min. The samples are dissolved in the eluent using a concentration of 5 mg polymer per mL solvent. The solubility is judged with a laser pen after 24 hours stabilization at room temperature; if any scattering is visible the samples are filtered first and 100 μl sample solution is injected. The molecular weight distribution results are calculated with 11 narrow poly methyl methacrylate standards from 645-1.677.000 Da. The obtained molar masses are poly methyl methacrylate equivalent molar masses (Dalton).

### pH

The pH is measured at room temperature on a Metrohm 691 using a pH glass electrode with pt-1000 temperature sensor. The pH meter is calibrated with buffer solutions of pH 7.00 and 9.21 prior to use.

### Acid Numbers (Acid Values AV)

The acid number AV originated from the carboxylate dispersing groups in polyurethane A (mg KOH/g polyurethane A) is calculated as follows:
Molar amount of carboxylate dispersing groups per g polyurethane A * 56100.

The acid number AV originated from the sulfonate dispersing groups in polyurethane A (mg KOH/g polyurethane A) is calculated as follows:
Molar amount of sulfonate dispersing groups per g polyurethane A * 56100.

TABLE 1
Overview (comparative) examples

| | | wt % | | AV | AV |
|---|---|---|---|---|---|
| | C═C | YMER | wt % | sulfonate | DMPA |
| | mmol/g | N120 in | EO in | groups [mg | [mg |
| | polyurethane | polyurethane | polyurethane | KOH/g] | KOH/g] |
| 1 | 4.9 | 15 | 12.6 | 4 | 4.1 |
| A | 4.9 | 15 | 12.6 | 4 | 0 |
| B | 5.0 | 15 | 12.6 | 0 | 4.1 |
| C | 5.0 | 15 | 12.6 | 0 | 8.1 |
| D | 5.0 | 15 | 12.6 | 8.1 | 0 |
| E | 5.0 | 0 | 0 | 4 | 4.1 |
| F | 4.5 | 15 | 12.6 | 4 | 0 |
| G | 4.5 | 15 | 12.6 | 0 | 4 |
| 2 | 3.9 | 20 | 16.8 | 4 | 4.1 |
| 3 | 3.2 | 15 | 12.6 | 4 | 4.1 |
| 4 | 1 | 15 | 14.7 | 4 | 4 |
| | | (MPEG750) | | | |
| 5 | 2.7 | 15 | 12.6 | 4 | 4.1 |

### EXAMPLE 1

A 2L reaction vessel was charged with pTHF650 (40 g), Agisyn 2830 (137 g), Ymer N120 (41 g), DMPA (2.7 g), IPDI (53 g), butylated hydroxytoluene (0.186 g) and bismuthneodecanoate (0.06 g). The mixture was heated to 90° C. with agitation. The reaction was held at 90° C. for three hours. The mixture was then cooled down to 65° C. and acetone (69 g) was added under stirring. The isocyanate content was measured via titration and reached a value of 1.09%. Then Vestamin® A95 (8.2 g) was added to the reaction mixture and stirred for 15 minutes at 45° C. Then a 15% solution of KOH (7.6 g) was added under stirring. After 10 minutes demineralized water (529 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids =32.7%, viscosity at 25° C.=91 mPas, average particle size is 32 nm and pH=8.2. The number average molecular weight=1929 g/mol and the weight average molecular weight=26024 g/mol.

The colloidal stability was assessed by observing sedimentation and/or phase separation and monitoring pH, viscosity and particle size PS in time at room temperature (RT) and 60° C.

TABLE 2
stability data of example 1 diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.7 | | 36 | | No | 4.7 | |
| 7 | days | 7.6 | 7.1 | 40 | 38 | No | 4.7 | 4.0 |
| 14 | days | 7.7 | 6.9 | 42 | 38 | No | 4.7 | 3.8 |
| 21 | days | 7.7 | 6.8 | 35 | 36 | No | 4.7 | 3.6 |
| 28 | days | 7.6 | 6.7 | 32 | 42 | No | 4.6 | 3.5 |
| 35 | days | 7.6 | 6.6 | 36 | 37 | No | 4.6 | 3.5 |
| 42 | days | 7.7 | 6.5 | 40 | 38 | No | 4.6 | 3.4 |

To further improve pH and visco stability 4% of a disodiumphosphate solution (8% in water) was added to the resulting dispersion of example 1. The stability data are given below in Table 2.

TABLE 3
stability data of example 1 diluted to 20 wt % solid content
containing 4 wt % of disodiumphosphate solution (8%)

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 8.0 | | 50 | | No | 3.0 | |
| 7 | days | 8.0 | 7.2 | 36 | 58 | No | 3.0 | 3.3 |
| 14 | days | 8.0 | 7.1 | 40 | 59 | No | 2.9 | 3.3 |
| 21 | days | 7.9 | 6.9 | 35 | 60 | No | 2.9 | 3.5 |
| 28 | days | 7.9 | 6.9 | 40 | 53 | No | 2.9 | 3.3 |
| 35 | days | 7.8 | 6.7 | 45 | 55 | No | 2.9 | 3.3 |
| 42 | days | 7.9 | 6.7 | 36 | 54 | No | 2.9 | 3.3 |

### Comparative Example A

A 2L reaction vessel was charged with pTHF650 (46 g), Agisyn 2830 (137 g), Ymer N120 (41 g), IPDI (50 g), butylated hydroxytoluene (0.186 g) and bismuthneodecanoate (0.06 g). The mixture was heated to 90° C. with agitation. The reaction was held at 90° C. for three hours. The mixture was then cooled down to 65° C. and acetone (69 g) was added under stirring. The isocyanate content was measured via titration and reached a value of 0.87%. Then Vestamin® A95 (8.2 g) was added to the reaction mixture and stirred for 15 minutes at 45° C. After 10 minutes demineralized water (539 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids =27.2%, viscosity at 25° C.=95 mPas, average particle size is 34 nm and pH=7.4.

TABLE 4
stability data of comp example A diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 6.9 | | 43 | | No | 13.1 | |
| 7 | days | 6.6 | 6.3 | 40 | 46 | No | 11.9 | 9.6 |
| 14 | days | 6.6 | 6.2 | 42 | 32 | No | 11.8 | 8.7 |
| 21 | days | 6.7 | 6.3 | 43 | 42 | No | 11.7 | 7.8 |
| 28 | days | 6.7 | 6.2 | 42 | 42 | No | 11.5 | 6.6 |
| 35 | days | 6.9 | 6.1 | 40 | 41 | No | 11.3 | 6.3 |
| 42 | days | 7.1 | 6.1 | 43 | 39 | No | 11.0 | 5.7 |

As can be seen from the results, there is already a significant pH drop after 7 days at 60° C. Further, the delta viscosity between the start and after 3 weeks storage at 60° C. is higher than 3 mPas. Further, the delta viscosity is >1 mPas when measured at 60° C. after 7 days and 28 days.

### Comparative Example B

A 2L reaction vessel was charged with pTHF650 (40 g), Agisyn 2830 (139 g), Ymer N120 (41 g), DMPA (2.7 g), IPDI (54 g), butylated hydroxytoluene (0.186 g) and bismuthneodecanoate (0.06 g). The mixture was heated to 90° C. with agitation. The reaction was held at 90° C. for three hours. The mixture was then cooled down to 65° C. and acetone (69 g) was added under stirring. The isocyanate content was measured via titration and reached a value of 1.04%. At 45° C. a 15% solution of KOH (7.6 g) was added under stirring. After 10 minutes mixing demineralized water (537 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids =34.7%, viscosity at 25° C.=65 mPas, average particle size is 50 nm and pH=7.8.

TABLE 5
stability data of comp example B diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.8 | | 53 | | No | 4.5 | |
| 7 | days | 7.6 | 7.1 | 51 | 51 | No | 4.0 | 3.4 |
| 14 | days | 7.5 | 6.9 | 49 | 52 | No | 4.0 | 3.2 |
| 21 | days | 7.6 | 6.5 | 49 | 57 | Yes | n.m.* | n.m.* |
| 28 | days | 7.4 | 6.0 | 50 | 72 | Yes | n.m.* | n.m.* |
| 35 | days | 7.5 | 5.8 | 45 | 167 | Yes | n.m.* | n.m.* |
| 42 | days | 7.6 | Phase | 43 | Phase | Phase | n.m.* | n.m.* |

| | | |
|---|---|---|
| sepa- | sepa- | sepa- |
| rated | rated | rated |

*n.m. = not measured

As can be seen from the results, the pH drops to a value of lower than 6.5 after 4 weeks upon storage at 60° C. Further, there is already a significant increase in particle size upon storage at 60° C. and samples stored at 60° C. show severe sedimentation of polymer. Therefore, assessment of the viscosity stability was stopped after observing sedimentation.

### Comparative Example C

A 2L reaction vessel was charged with pTHF650 (55 g), Agisyn 2830 (220 g), Ymer N120 (66 g), DMPA (8.5 g), IPDI (90 g), butylated hydroxytoluene (0.3 g) and bismuthneodecanoate (0.2 g). The mixture was heated to 80° C. with agitation. The reaction was held at 80° C. for three hours. The mixture was then cooled down to 65° C. and acetone (110 g) was added under stirring. The isocyanate content was measured via titration and reached a value of 1.84%. At 45° C. a 15% solution of KOH (23.8 g) was added under stirring. After 10 minutes mixing demineralized water (834 g) was added under high shear agitation until a stable dispersion was formed. Byk011 (0.09 g) was added and the acetone was stripped off under vacuum at a temperature of 45° C. The dispersion was then cooled and filtered over a 100 μ filter cloth. The final dispersion had the following properties: wt % solids =36.1%, viscosity at 25° C.=22 mPas, average particle size is 69 nm and pH=7.1. The pH was increased to 8.0 by addition of KOH.

TABLE 6
stability data of comp example C diluted to 20 wt % solid content.

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 8.0 | | 69 | | No | 3.0 | |
| 7 | days | 7.6 | 7.2 | 72 | 68 | No | 2.6 | 2.7 |
| 14 | days | 7.7 | 7.0 | 70 | 65 | No | 2.8 | 2.7 |
| 21 | days | 7.8 | 6.7 | 73 | 66 | No | 2.8 | 2.7 |
| 28 | days | 7.7 | 6.4 | 81 | 63 | No | 2.9 | 2.7 |
| 35 | days | 7.8 | 6.0 | 69 | 66 | No | 2.8 | 2.7 |
| 42 | days | 7.8 | 5.6 | 71 | 71 | No | 2.8 | 2.5 |

As can be seen from the results, the pH drops to a value of lower than 6.5 after 4 weeks upon storage at 60° C.

### Comparative Example D

A 2L reaction vessel was charged with pTHF650 (73 g), Agisyn 2830 (220 g), Ymer N120 (66 g), IPDI (80 g), butylated hydroxytoluene (0.3 g) and bismuthneodecanoate (0.2 g). The mixture was heated to 80° C. with agitation. The reaction was held at 80° C. for three hours. The mixture was then cooled down to 65° C. and acetone (110 g) was added under stirring.

The isocyanate content was measured via titration and reached a value of 1.82%. Then Vestamin® A95 (28.3 g) was added to the reaction mixture and stirred for 15 minutes at 40° C. After 10 minutes demineralized water (834 g) was added under high shear agitation until a stable dispersion was formed. Byk011 (0.09 g) was added and the acetone was stripped off under vacuum at a temperature of 45° C. The dispersion was then cooled and filtered over a 100 μ filter cloth. The final dispersion had the following properties: wt % solids =35.2%, viscosity at 25° C.=1700 mPas, average particle size is 32 nm and pH=7.1. The pH was increased to 7.4 by addition of KOH.

TABLE 7
stability data of comp example D diluted to 20 wt % solid content.

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.4 | | 32 | | No | 6.4 | |
| 7 | days | 6.6 | 6.9 | 37 | 34 | No | 6.4 | 6.2 |
| 14 | days | 6.7 | 6.9 | 34 | 31 | No | 6.5 | 5.9 |
| 21 | days | 6.9 | 6.5 | 34 | 33 | No | 6.3 | 5.3 |
| 28 | days | 7.1 | 6.4 | 34 | 30 | No | 6.3 | 5.1 |
| 35 | days | 7.1 | 6.4 | 33 | 29 | No | 6.5 | 4.9 |
| 42 | days | 7.4 | 6.2 | 33 | 30 | No | 6.4 | 4.5 |

As can be seen from the results, the pH drops to a value of lower than 6.5 after 4 weeks upon storage at 60° C. Secondly, the delta viscosity is >1 mPas s when measured at 60° C. after 7 days and 28 days.

### Comparative Example E

A 2L reaction vessel was charged with pTHF650 (123 g), Agisyn 2830 (220 g), DMPA (4.4 g), IPDI (92 g), butylated hydroxytoluene (0.3 g) and bismuthneodecanoate (0.2 g). The mixture was heated to 80° C. with agitation. The reaction was held at 80° C. for three hours. The mixture was then cooled down to 65° C. and acetone (110 g) was added under stirring. The isocyanate content was measured via titration and reached a value of 2.11%. Then Vestamin® A95 (13.8 g) was added to the reaction mixture and stirred for 15 minutes at 40° C. Then a 15% solution of KOH (12.3 g) was added under stirring. After 10 minutes demineralized water (849 g) was added under high shear agitation until a stable dispersion was formed. Byk011 (0.09 g) was added and the acetone was stripped off under vacuum at a temperature of 45° C. The dispersion was then cooled and filtered over a 100 μ filter cloth. The final dispersion had the following properties: wt % solids=34.9%, viscosity at 25° C.=31 mPas, average particle size is 132 nm and pH=6.6.

TABLE 8
stability data of comp example E diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 6.6 | | 130 | | No | 2.0 | |
| 7 | days | 6.7 | 7.0 | 129 | 129 | No | 2.1 | 2.1 |
| 14 | days | 6.8 | 7.1 | 130 | 130 | No | 2.0 | 2.1 |
| 21 | days | 7.0 | 6.7 | 132 | 132 | No | 2.0 | 2.0 |
| 28 | days | 7.2 | 6.4 | 127 | 131 | No | 2.1 | 2.0 |
| 35 | days | 7.3 | 6.0 | 129 | 127 | No | 2.1 | 2.0 |
| 42 | days | 7.3 | 5.6 | 130 | 130 | No | 2.1 | 1.9 |

As can be seen from the results, the pH drops to a value of lower than 6.5 after 4 weeks upon storage at 60° C.

### Comparative Example F

A 2L reaction vessel was charged with pTHF1000 (46 g), Agisyn 2884 (125 g), Ymer N120 (41 g), IPDI (62 g), butylated hydroxytoluene (0.2 g) and bismuthneodecanoate (0.12 g). The mixture was heated to 90° C. with agitation. The reaction was held at 90° C. for three hours. The mixture was then cooled down to 65° C. and acetone (69 g) was added under stirring. The isocyanate content was measured via titration and reached a value of 1.07%. Then Vestamin® A95 (8.2 g) was added to the reaction mixture and stirred for 15 minutes at 40° C. After 10 minutes demineralized water (640 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids=30.7%, viscosity at 25° C.=64 mPas, average particle size is 44 nm and pH=5.7. The pH was increased to 7.5 by the addition of KOH.

TABLE 9
stability data of comp example F diluted to 20 wt % solid content.

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.5 | | 72 | | No | 4.6 | |
| 7 | days | 6.6 | 5.8 | 52 | 49 | Little | 4.7 | 4.6 |
| 14 | days | 6.6 | 5.9 | 48 | 47 | Little | 4.7 | 4.3 |
| 21 | days | 6.5 | 5.9 | 51 | 45 | Little | 4.8 | 3.9 |
| 28 | days | 6.5 | 5.7 | 49 | 47 | Little | 5.0 | 3.7 |
| 35 | days | 6.5 | 5.6 | 50 | 47 | Little | 4.9 | 3.6 |
| 42 | days | 6.6 | 5.5 | 50 | 47 | Little | 5.0 | 3.3 |

As can be seen from the results, the pH drops to a value of lower than 6.5 after 4 weeks upon storage at 60° C. Secondly, the delta viscosity is >0.5 mPas s when measured at 60° C. after 7 days and 28 days. Further the change in particle size of the dispersion stored at room temperature or at 60° C. for 4 weeks is >20 nm, and the change in particle is >30% when stored for 4 weeks at room temperature. Furthermore, samples stored at 60° C. show sedimentation within 1 week.

### Comparative Example G

A 2L reaction vessel was charged with pTHF1000 (44 g), Agisyn 2884 (127 g), Ymer N120 (42 g), DMPA (2.7 g), IPDI (63 g), butylated hydroxytoluene (0.2 g) and bismuthneodecanoate (0.12 g). The mixture was heated to 90° C. with agitation. The reaction was held at 90° C. for three hours. The mixture was then cooled down to 65° C. and acetone (70 g) was added under stirring. The isocyanate content was measured via titration and reached a value of 0.94%. At 45° C. a 15% solution of KOH (7.5 g) was added under stirring. After 10 minutes mixing demineralized water (516 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids =35.2%, viscosity at 25° C.=21 mPas, average particle size is 72 nm and pH=7.1. The pH was increased to 8.0 by addition of KOH.

TABLE 10
stability data of comp example G diluted to 20 wt % solid content.

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.9 | | 78 | | No | 3.1 | |
| 7 | days | 7.6 | 6.0 | 72 | 137 | No | 2.8 | 2.3 |
| 14 | days | 7.6 | 5.5 | 68 | 126 | Little | 2.9 | 2.3 |
| 21 | days | 7.5 | 5.1 | 65 | 117 | Little | 2.8 | 2.2 |
| 28 | days | 7.5 | 5.1 | 63 | 110 | Little | 2.8 | 2.2 |
| 35 | days | 7.5 | 4.9 | 65 | 164 | Little | 2.7 | 2.3 |
| 42 | days | 7.4 | 4.7 | 64 | 104 | Little | 2.7 | 2.2 |

As can be seen from the results, the pH drops to a value of lower than 6.5 after 1 week upon storage at 60° C. In addition, particle size increases >20 nm upon storage at 60° C. Furthermore, samples stored at 60° C. show sedimentation within 2 weeks.

### EXAMPLE 2

A 2L reaction vessel was charged with pTHF650 (46 g), Agisyn 2830 (108 g), Ymer N120 (55 g), DMPA (2.7 g), DesW (61 g), butylated hydroxytoluene (0.186 g) and bismuthneodecanoate (0.06 g). The mixture was heated to 90° C. with agitation. The reaction was held at 90° C. for three hours. The mixture was then cooled down to 65° C. and acetone (69 g) was added under stirring. The isocyanate content was measured via titration and reached a value of 0.84%. Then Vestamin® A95 (8.2 g) was added to the reaction mixture and stirred for 15 minutes at 45° C. Then a 15% solution of KOH (7.6 g) was added under stirring. After 10 minutes demineralized water (529 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids =31.6%, viscosity at 25° C.=99 mPas, average particle size is 21 nm and pH=8.5. The number average molecular weight=2681 g/mol and the weight average molecular weight =40392 g/mol.

TABLE 11
stability data of example 2 diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 8.4 | | 35 | | No | 5.8 | |
| 7 | days | 7.9 | 7.2 | 33 | 43 | No | 5.3 | 4.4 |
| 14 | days | 7.8 | 7.0 | 34 | 37 | No | 5.1 | 4.1 |
| 21 | days | 7.7 | 6.9 | 32 | 35 | No | 5.1 | 3.9 |
| 28 | days | 7.7 | 6.8 | 29 | 36 | No | 5.0 | 4.0 |
| 35 | days | 7.7 | 6.7 | 26 | 28 | No | 5.0 | 3.9 |
| 42 | days | 7.8 | 6.6 | 27 | 28 | No | 5.0 | 3.9 |

### EXAMPLE 3

A 2L reaction vessel was charged with pTHF650 (58 g), Agisyn 2830 (55 g), Agisyn 2824 (55 g), Ymer N120 (41 g), DMPA (2.7 g), IPDI (63 g), butylated hydroxytoluene (0.186 g) and bismuthneodecanoate (0.06 g). The mixture was heated to 90° C. with agitation. The reaction was held at 90° C. for three hours. The mixture was then cooled down to 65° C. and acetone (69 g) was added under stirring. The isocyanate content was measured via titration and reached a value of 1.25%. Then Vestamin® A95 (8.2 g) was added to the reaction mixture and stirred for 15 minutes at 45° C. Then a 15% solution of KOH (7.6 g) was added under stirring. After 10 minutes demineralized water (529 g) was added under high shear agitation until a stable dispersion was formed. Byk011 (0.04 g) was added and the acetone was stripped off under vacuum at a temperature of 45° C. The dispersion was then cooled and filtered over a 100 μ filter cloth. The final dispersion had the following properties: wt % solids =33.1%, viscosity at 25° C.=96mPas, average particle size is 68 nm and pH=8.2. The number average molecular weight=3501 g/mol and the weight average molecular weight =37894 g/mol.

The colloidal stability was assessed by observing sedimentation and/or phase separation and monitoring pH, viscosity and particle size.

TABLE 12
stability data of example 3 diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 8.3 | | 65 | | | 6.2 | |
| 7 | days | 8.1 | 7.2 | 68 | 72 | No | 5.9 | 4.5 |
| 14 | days | 8.0 | 7.0 | 65 | 68 | No | 5.7 | 4.5 |
| 21 | days | 8.0 | 6.9 | 61 | 59 | No | 5.4 | 4.2 |
| 28 | days | 7.9 | 6.8 | 60 | 63 | No | 5.2 | 4.2 |
| 35 | days | 7.8 | 6.7 | 58 | 57 | No | 5.0 | 4.2 |
| 42 | days | 7.8 | 6.7 | 61 | 57 | No | 5.0 | 4.1 |

### EXAMPLE 4

A 2L reaction vessel was charged with pTHF1000 (97 g), Agisyn 1010 (92 g), MPEG750 (51 g), DMPA (3.3 g), IPDI (99 g), butylated hydroxytoluene (0.2 g), acetone (145 g) and bismuthneodecanoate (0.3 g). The mixture was heated to 60° C. with agitation. The reaction was held at 60° C. for ten hours. The isocyanate content was measured via titration and reached a value of 1.47%. Then Vestamin® A95 (10.2 g) was added to the reaction mixture and stirred for 15 minutes at 45° C. Then a 15% solution of KOH (9.3 g) was added under stirring. After 10 minutes demineralized water (666 g) was added under high shear agitation until a stable dispersion was formed. Byk011 (0.05 g) was added and the acetone was stripped off under vacuum at a temperature of 45° C. The dispersion was then cooled and filtered over a 100 μ filter cloth. The final dispersion had the following properties: wt % solids =36.2%, viscosity at 25° C.=56mPas, average particle size is 55 nm and pH=6.4. The number average molecular weight=7502 g/mol and the weight average molecular weight =682097 g/mol. The pH was increased to 7.5 by the addition of KOH.

TABLE 13
stability data of example 4 diluted to 20 wt % solid content.

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.5 | | 57 | | No | 4.8 | |
| 7 | days | 7.5 | 7.5 | 57 | 64 | No | 4.7 | 3.5 |
| 14 | days | 7.5 | 7.2 | 56 | 60 | No | 4.6 | 3.4 |
| 21 | days | 7.4 | 7.3 | 57 | 54 | No | 4.6 | 3.4 |
| 28 | days | 7.5 | 7.5 | 56 | 53 | No | 4.5 | 3.4 |
| 35 | days | 7.5 | 7.6 | 57 | 52 | No | 4.5 | 3.3 |
| 42 | days | 7.6 | 7.6 | 57 | 53 | No | 4.6 | 3.2 |

### EXAMPLE 5

A 2L reaction vessel was charged with pTHF650 (66 g), Agisyn 2830 (34 g), Agisyn 2824 (163 g), Ymer N120 (66 g), DMPA (4.4 g), IPDI (106 g), butylated hydroxytoluene (0.3 g) and bismuthneodecanoate (0.2 g). The mixture was heated to 80° C. with agitation. The reaction was held at 80° C. for three hours. The mixture was then cooled down to 65° C. and acetone (69 g) was added under stirring. The isocyanate content was measured via titration and reached a value of 2.62%. Then Vestamin® A95 (13.8 g) was added to the reaction mixture and stirred for 15 minutes at 45° C. Then a 15% solution of KOH (12.3 g) was added under stirring. After 10 minutes demineralized water (849 g) was added under high shear agitation until a stable dispersion was formed. Byk011 (0.09 g) was added and the acetone was stripped off under vacuum at a temperature of 45° C. The dispersion was then cooled and filtered over a 100 μ filter cloth. The final dispersion had the following properties: wt % solids =36.3%, viscosity at 25° C.=53 mPas, average particle size is 42 nm and pH=7.0. The number average molecular weight=4121 g/mol and the weight average molecular weight =31941 g/mol.

TABLE 14
stability data of example 5 diluted to 20 wt % solid content

| | | pH | | PS [nm] | | Sedimentation | Viscosity [mPas] | |
|---|---|---|---|---|---|---|---|---|
| | | Temperature [° C.] | | | | | | |
| | | RT | 60 | RT | 60 | 60 | RT | 60 |
| Start | | 7.1 | | 40 | | No | 3.4 | |
| 7 | days | 7.0 | 7.1 | 42 | 40 | No | 3.5 | 3.6 |
| 14 | days | 7.2 | 7.3 | 41 | 38 | No | 3.7 | 3.5 |
| 21 | days | 7.2 | 7.0 | 41 | 39 | No | 3.7 | 3.4 |
| 28 | days | 7.4 | 6.9 | 41 | 39 | No | 3.8 | 3.4 |
| 35 | days | 7.5 | 6.8 | 41 | 40 | No | 3.7 | 3.3 |
| 42 | days | 7.5 | 6.8 | 42 | 39 | No | 3.8 | 3.3 |

1. A radiation-curable aqueous dispersion comprising a (meth)acryloyl functional polyurethane A comprising anionic dispersing groups and non-ionic dispersing groups, wherein
(i) said polyurethane A comprises (meth)acryloyl ester functional groups in an amount of at least 0.5 mmol per g of the polyurethane A,
(ii) said anionic dispersing groups comprising carboxylate and sulfonate dispersing groups,
(iii) said carboxylate and sulfonate dispersing groups are present in said polyurethane A in an amount such as to result in an acid number of from 2 to 30 mg KOH/g of the polyurethane A,
(iv) said carboxylate and sulfonate dispersing groups are individually present in said polyurethane A in an amount such as to result in an acid number of from 1 to 15 mg KOH/g of said polyurethane A,
(v) said non-ionic dispersing groups are polyethylene oxide dispersing groups composed of at least 5 ethylene oxide repeating units, and
(i) said polyethylene oxide dispersing groups are present in said polyurethane A such that the ethylene oxide content in the polyurethane A is from 2 to 20 wt. %.

2. The dispersion according to claim 1, wherein the amount of (meth)acryloyl ester functional groups in said polyurethane A is at least 1.0 mmol per g of said polyurethane A, preferably at least 2.0 mmol per g of said polyurethane A, and at most 10 mmol per g of said polyurethane A, preferably at most 8 mmol per g of said polyurethane A and most preferably at most 7 mmol per g of said polyurethane A.

3. The dispersion according to claim 1, wherein the amount of (meth)acryloyl ester functional groups, more preferably acryloyl ester groups, present in said polyurethane A is chosen such to result in at least 50 mol % of the ethylenically unsaturated bond concentration of said polyurethane A, more preferably at least 75 mol %, even more preferably at least 90 mol % and most preferably 100 mol % of the ethylenically unsaturated bond concentration of said polyurethane A.

4. The dispersion according to claim 1, wherein said polyurethane A comprises acryloyl ester functional groups.

5. The dispersion according to claim 1, wherein said (meth)acryloyl ester functional groups are introduced in said polyurethane A by chemically incorporating hydroxyethyl(meth)acrylate, hydroxypropyl(meth)acrylate, hydroxybutyl(meth)acrylate and any mixture thereof and/or trimethylolpropane di(meth)acrylate, pentaerythritol tri(meth)acrylate and their (poly)ethoxylated and/or (poly)propoxylated equivalents, dipentaerythritol penta(meth)acrylate and their poly)ethoxylated and/or (poly)propoxylated equivalents, ditrimethylolpropane tri(meth)acrylate and their (poly)ethoxylated and (poly)propoxylated equivalents and any mixture thereof into said polyurethane A.

6. The dispersion according to claim 1, wherein said carboxylate and sulfonate dispersing groups are present in said polyurethane A in an amount such as to result in an acid number of at least 3 mg KOH/g of said polyurethane A, more preferably at least 4 mg KOH/g of said polyurethane A and preferably at most 20 mg KOH/g of said polyurethane A, more preferably at most 16 mg KOH/g of said polyurethane A, more preferably at most 12 mg KOH/g of said polyurethane A.

7. The dispersion according to claim 1, wherein said carboxylate and sulfonate dispersing groups are individually present in said polyurethane A in an amount such as to result in an acid number of at least 2 mg KOH/g of said polyurethane A, more preferably at least 3 mg KOH/g of said polyurethane A and preferably at most 12 mg KOH/g of said polyurethane A, more preferably at most 10 mg KOH/g of said polyurethane A.

8. The dispersion according to claim 1, wherein said polyethylene oxide dispersing groups are present in said polyurethane A such as to result in an ethylene oxide content of at least 5 wt. %, more preferably at least 7 wt. % and preferably at most 18 wt. %, more preferably at most 16 wt. %.

9. The dispersion according to claim 1, wherein said carboxylate dispersing groups are introduced into said polyurethane A by chemically incorporating carboxylic acid groups which become anionic when deprotonated with one or more neutralizing agents, preferably with alkali metal hydroxide.

10. The dispersion according to claim 1, wherein a hydroxy-carboxylic acid, preferably a dihydroxy alkanoic acid, more preferably a,a-dimethylolpropionic acid, is chemically incorporated into said polyurethane A to provide after deprotonation a part of the hydrophilicity required to enable said polyurethane A to be stably dispersed in the aqueous dispersing medium.

11. The dispersion according to claim 1, wherein said sulfonate dispersing groups are introduced into said polyurethane A by chemically incorporating at least one sulfonate containing compound into said polyurethane A, preferably by using a sulfonate containing compound as reactant after the prepolymer preparation, wherein the sulfonate containing compound is a diaminosulphonate corresponding to the following general formula: H₂N—A—NH—B—SO₃—Cat⁺ wherein A and B represent aliphatic hydrocarbon radicals having from 2 to 6 carbon atoms, preferably ethylene radicals, and Cat⁺ represents an optionally substituted ammonium cation or a sodium or potassium cation.

12. The dispersion according to claim 1, wherein said polyethylene oxide dispersing groups are introduced in said polyurethane A by chemically incorporating at least one polyethylene glycol having at least 5 ethylene oxide repeating units, preferably at least 10, more preferably at least 15 ethylene oxide repeating units and preferably at most 120, more preferably at most 80 and even more preferably at most 40 ethylene oxide repeating units.

13. The dispersion according to claim 1, wherein the number average molecular weight Mₙ of said polyurethane A is in the range from 800 to 50000 Daltons, more preferably in the range of 1000 to 25000 Daltons, most preferably in the range of 1100 to 20000 Daltons, especially preferred in the range of 1200 to 15000 Daltons.

14. The dispersion according to claim 1, wherein the isocyanate and isocyanate reactive groups of the components used to prepare the polyurethane A (excluding water as chain extending compound) are present in a respective mole ratio of ≤1.5:1, more preferably in the range of from 0.8:1 to 1.5:1, preferably from 1.05:1 to 1.5:1 and even more preferably from 1.1:1 to 1.5:1

15. The dispersion according to claim 1, wherein said polyurethane A comprises as building blocks
(a) at least one polyisocyanate,
(b) at least one component containing at least one isocyanate-reactive group and containing or providing at least one (meth)acryloyl ester functional group,
(c) at least one component containing at least one isocyanate-reactive group and at least one carboxylate dispersing group, whereby component (c) being different from component (b),
(d) at least one component containing at least one isocyanate-reactive group and at least one sulfonate dispersing group, whereby component (d) being different from component (b) and (c),
(e) at least one component containing at least one isocyanate-reactive group and polyethylene oxide dispersing groups, whereby component (e) being different from component (b), (c) and (d),
(f) optionally at least one active-hydrogen chain-extending component different from component (b), (c), (d) and (e), and (g) optionally at least one component containing at least two isocyanate-reactive
groups, whereby component (g) being different from component (b), (c), (d), (e) and (f).

16. The dispersion according to claim 15, wherein component (g), if used, is one or more polyether polyol.

17. The dispersion according to claim 15, wherein the amount of component (g) used for preparing said polyurethane A is less than 30 wt. %, more preferably less than 25 wt. %, more preferably less than 20 wt. %, more preferably less than 15 wt. %.

18. The dispersion according to claim 1, wherein the dispersed particles have an average particle size of 15 nm or higher and of 200 nm or lower.

19. Ink comprising the dispersion according to claim 1, wherein the amount of said polyurethane A is in the range from 1 to 25 wt. %, preferably from 2 to 20 wt. %, relative to the total weight of the ink.
